(19) United States
(12) Patent Application Publication
(10) Pub. No.: US 2025/0097105 A1
(43) Pub. Date: Mar. 20, 2025

(54) A METHOD OF AND A SYSTEM FOR IDENTIFYING ASSOCIATION OF A BACKHAUL UNIT TO A NODE DEVICE CONNECTED TO THE BACKHAUL UNIT IN A NETWORK

(71) Applicant: SIGNIFY HOLDING B.V., EINDHOVEN (NL)

(72) Inventors: XIAOBO JIANG, SHANGHAI (CN); HUA XU, SHANGHAI (CN)

(21) Appl. No.: 18/730,469

(22) PCT Filed: Jan. 17, 2023
(86) PCT No.: PCT/EP2023/050962

§ 371 Date: Jul. 19, 2024

(30) Foreign Application Priority Data
Jan. 21, 2022 (WO) PCT/CN2022/073312
Mar. 8, 2022 (EP) 22160762.5

(51) Int. Cl. H04L 41/0823; H04L 43/0888; H04L 47/70; H04L 47/80

(52) U.S. Cl. CPC H04L 41/0823; H04L 43/0888; H04L 47/803; H04L 47/822; H04L 47/826

(57) ABSTRACT

A method of identifying association of a backhaul unit to a node device connected to the backhaul unit in a network is disclosed. The network comprises a plurality of backhaul units each arranged for connecting to a node device and for providing network connection to the node device. The method comprises the steps of: obtaining a data consumption pattern related to a node device over a time period; obtaining data consumption patterns of the plurality of backhaul units over the same time period; matching the data consumption pattern of the node device to one of the data consumption patterns of the plurality of backhaul units; and identifying association of the node device to a backhaul unit having the matched data consumption pattern.

### TECHNICAL FIELD

The present disclosure generally relates to the field of commissioning of node devices in a network, more particularly, to a method of and a system for identifying association of a backhaul unit to a node device connected to the backhaul unit in a network.

### BACKGROUND

Backhaul units or backhaul nodes with higher throughput capacities, such as up to Gigabit capacities, are employed in various application scenarios for building up mesh network as well as links between nodes and servers, allowing customer data to be exchanged in a faster and more reliable fashion.

One application of backhaul units involves deploying backhaul units in streetlighting systems for enabling future smart pole devices with network service. The backhaul units are configured with Power over Ethernet, PoE, ports or connectable to PoE switches, making them especially suitable for smart lighting systems, allowing PoE node devices comprising lighting controllers, cameras and various sensor to be connected to the network via the backhaul unit.

EP3700145 A1 relates to association of a user device with a radio node in a wireless network by selecting a best associating path according to a performance criterion including data throughput.

For the purpose of asset management and control, it is necessary that association between connected PoE devices with the backhaul unit is correctly identified. The association of node devices to the backhaul unit, as a first step of asset management, is of much importance to cloud applications, as the subsequent device control, monitoring and management are only feasible after the association.

In real life applications, it is often that the backhaul node and the node devices connected thereto come from different entities, which makes it difficult or even impossible for owners of the connected node devices to modify the firmware of the backhaul unit, which renders conventional association approaches as described below infeasible. Other methods may be too time and resource consuming or error prone and therefore not desirable.

According to one association method, a field engineer manually takes down the unique identifications, IDs, of the node devices and the associated backhaul units and upload the same to the cloud. This method is disadvantageous in that much manual effort in the field is needed.

Another association method relies on GPS locations from respective devices. This method requires that each node device be equipped with a GPS module, which will increase the cost of the system. Moreover, a GPS itself may drift, which will render the location provided by the GPS module not reliable.

Still another association method establishes the association by powering on/off the node devices and monitoring the device status. This method will power on/off the node devices, it may therefore interrupt normal operation of the customer devices. Moreover, with this method it takes very long to commission a large installation, since switching on/off multiple device simultaneously leads to difficulty of differentiation with each other.

Another exemplary association method involves adding an edge device to detect the association, this is due to lack of control of the backhaul node's firmware. This method increases the cost to add the edge device, and can further cause concern on the edge device to the customer, as there might be relevant data security issues and tapping on the network.

In consideration of the above, there is a genuine need of a method of identifying the association between the backhaul unit and the connected node devices in an automatic, reliable and convenient way.

### SUMMARY

In a first aspect of the present disclosure, there is presented method of identifying association of a backhaul unit to a node device connected to the backhaul unit in a network, the network comprising a plurality of backhaul units each arranged for connecting to a node device and for providing network connection to the node device, the method comprising the steps of:
obtaining a data consumption pattern related to a node device over a time period;
obtaining data consumption patterns of the plurality of backhaul units over the same time period;
matching the data consumption pattern related to the node device to one of the data consumption patterns of the plurality of backhaul units; and
identifying association of the node device to a backhaul unit having the matched data consumption pattern.

The present disclosure is based on the insight that information on node devices each connected to a backhaul unit, available from the backhaul units connecting the node devices, may be used to identify association between the backhaul units and the connected node devices.

The information available from the backhaul units to a remote device, such as a backend server with various remote or cloud applications running thereon, belongs to the type of information that the remote device or application can obtain easily, such as data consumption of the node devices connected to the backhaul units. The method therefore involves obtaining data consumption pattern related to a node device, the data consumption happened or will happen in over a time period. Thereafter, data consumption patterns at a plurality of backhaul units, one of which connected to the node devices, are acquired. The method can therefore match the data consumption pattern related to the node device to one of the data consumption patterns of the backhaul units. The backhaul unit with the matched data consumption pattern is thereby identified as being associated with the node device.

The method as described above enables identification of association between node devices and backhaul units connecting the node devices to the network, without relying our human interference or additional devices such as GPS or edge devices. The method is implemented by way of regular communication between a device or application obtaining and processing the data consumptions patterns and the node devices as well as the backhaul units. As a result, no extra controlling of the node devices is required, which can prevent any possible damage to the node devices due to unnecessary switch between on and off.

As the backhaul unit is of high throughput capacity, communication cost involved in the above method will not be a problem.

In an example of the present disclosure, the data consumption pattern related to the node device is negotiated by a remote application with the node device, the method comprising, subsequent to the step of obtaining a data consumption pattern related to a node device over a time period, a further step of:
aligning with the node device about the time period of the data consumption pattern.

Each node device is a plug and play type nodes, which once gets connected to the backhaul unit and powered up, will be connected to the internet and register itself with a remote device or application such as a cloud application. The node device is therefore ready for remote calls and control automatically after being connected.

The remote application, upon obtaining the identification of the node device, can easily negotiate a defined data consumption pattern, such as via an Application Programming Interface, API, or a dedicated communication protocol. The thus negotiated data consumption pattern is for use in identifying association of the node device with the backhaul unit and inherently known to the remote application.

The agreed data consumption pattern may be transformed by the remote application into a command and then transmitted to the node device, based on available communication protocol, which does not involve any modification to existing communication method in the network.

It can be understood by those skilled in the art when the data consumption pattern of the related node device shall happen can be conveniently aligned with the node device, which will allow the cloud application to know when to detect the data consumption pattern accordingly and perform the method of the present disclosure.

In an example of the present disclosure, the data consumption pattern related to the node device is obtained from the node device, the step of obtaining data consumption patterns of the plurality of backhaul units over the same time period comprises retrieving stored data consumption patterns of the plurality of backhaul units over the same time period.

In the case that a remote device or a cloud application has more control over some node devices, allowing more information about a node device to be known to the remote device or cloud application, a node device can actively consume data according to a pattern in a time period, and report the data consumption pattern to the remote device or cloud application.

In this case, the data consumption patterns of the plurality of backhaul units are available to the remote device or cloud application, as it regularly polls each backhaul unit for its statistics including the data consumptions. It can extract the accumulating RX/TX counter of the backhaul units. The cloud application can thereby know how much data is consumed on a port of the backhaul unit in both the uplink and downlink directions in every minute. The remote device or cloud application can therefore retrieve the data consumption patterns of the plurality of backhaul units over the same time period, thereafter performing the matching step as described.

In an example of the present disclosure, the data consumption pattern related to a node device comprises a number of data consumptions in consecutive time frames of the same number.

This is a simple way of forming a pattern from different data consumptions taking place in a number of continuous or consecutive time frames. By varying the data consumption in different time frames, the data consumption pattern can be made unique for each node device, making the subsequent mapping of the data consumption pattern related to the node device to the data consumption patterns of the backhaul units easier.

In an example of the present disclosure, the data consumption pattern related to a node device further comprises at least one of volume of each data consumption, a direction of each data consumption and presence/absence of each data consumption.

These further parameters of the data consumption pattern related to a node device allow data consumption patterns for different node devices to be differentiated in more aspect. The parameters can be conveniently combined to generate data consumption patterns suitable for various type of node devices.

In an example of the present disclosure, each non-zero data consumption is at least one kilobytes in each time frame.

It can be contemplated by those skilled in the art each data consumption should be detectable for the remote application, a minimum size of 1 KB is sufficient for this purpose. An amount higher than the minimum size may be chosen freely.

In an example of the present disclosure, a backhaul unit comprises a plurality of communication ports,
the step of obtaining data consumption patterns of the plurality of backhaul units over the same time period comprises obtaining data consumption of each communication ports of the plurality of backhaul unit over the same time period;
the step of matching comprises matching the data consumption pattern related to the node device to one of the data consumption patterns of communication ports of the plurality of backhaul units; and
the step of identifying association comprises identifying association of the node device to a communication port of a backhaul unit having the matched data consumption pattern.

A backhaul unit may support several ports such as several Power over Ethernet, PoE, ports of a POE switch connected to the backhaul unit. In this case, the node device is associated to a specific port supported by the backhaul unit which is performed according to the steps as described above.

In an example of the present disclosure, the step of matching comprises the steps of:
calculating an indicator of relevance of the data consumption pattern related to the node device with each data consumption pattern of the backhaul units; and
matching the data consumption pattern related to the node device to a data consumption pattern of the backhaul with an indicator indicating a highest relevance.

In practice, the matching may be performed for a group of node devices simultaneously. The cloud application can start and negotiate with multiple node devices in parallel via their APIs. By crosschecking the consumption patterns obtained from the backhaul nodes and the data consumption pattern assigned for each of a group of node device, such as by calculating a covariance matrix between the data consumption patterns related to the group of node devices and the data consumption patterns of the backhaul units, the cloud application can match the data consumption pattern related to each node device to a corresponding one of the data consumption patterns of the backhaul units.

Commissioning and association for multiple devices based on the above method in parallel can help to improve the speed of commissioning and association significantly.

In an example of the present disclosure, the indicator of relevance is based on a covariance or a Pearson coefficient between the data consumption pattern related to the node device and each data consumption pattern of the backhaul units.

The covariances and Pearson coefficient may indicate which backhaul unit has a data consumption pattern corresponding to the data consumption pattern related to the node device. Algorithm for performing such calculation is well known in the art and does not cost much extra effort to implement.

In an example of the present disclosure, the indicator of relevance is further based on absolute values of the data consumption pattern related to the node device and of each data consumption pattern of the backhaul units.

The amount of a data consumption of the data consumptions patterns may be used as a further criteria for determining or identifying the association between the backhaul units and the node devices. As an example, two very different data consumption by two different node devices, for example, one device consumes 10M in the timeframe, and the other only consumes 10K in the timeframe, can be used as an additional factor for identifying the association. This is a very straightforward and simple criterion.

In an example of the present disclosure, the method further comprises the step of blocking the node device from creating data consumption above a defined threshold during the time period.

It helps to increase the accuracy of the association procedure, as large data consumption may interfere with the acquiring of the data consumption patterns from the backhaul units.

In an example of the present disclosure, each node device is identified by a unique node identification, each backhaul unit is identified by a unique backhaul identification, the step of identifying association comprises identifying association of a unique node identification of the node device with a unique backhaul identification of a backhaul unit having the matched data consumption pattern.

As can be contemplated by those skilled in the art, the association between the node devices and the backhaul units as discussed in the present disclosure is based on respective IDs of the node devices and the backhaul units, which may be performed as a part of a commissioning procedure for setting up the network.

It can be contemplated by those skilled in the art that a unique ID such as MAC addresses of node devices are sufficient for differentiating the node devices. For convenience considerations, a node identification of a node device may be an identification obtained based on a network address and a batch number, as the thus obtained node ID can be made simpler, which can be more conveniently used.

In an example of the present disclosure, each backhaul unit is installed on a light pole and comprises a Power over Ethernet, PoE, port, and a node device comprises at least one of a lighting controller, a camera and a sensor.

The method as described above is especially suitable for a streetlighting system comprising backhaul units installed on the light poles, with various node devices connected to the backhaul units.

A second aspect of the present disclosure provides a system for identifying association of a backhaul unit to a node device connected to the backhaul unit in a network, according to the method according to the first aspect of the present disclosure, the network comprising a plurality of backhaul units each arranged for connecting to a node device and for providing network connection to the node device.

A third aspect of the present disclosure provides a computer program product, comprising a computer readable storage medium storing instructions which, when executed on at least one processor, cause said at least one processor to carry out the method according to the first aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 schematically illustrates a system in which node devices of a network are provided with network connectivity by way of backhaul nodes, in accordance with an embodiment of the present disclosure.

FIGS. 2a to 2c schematically illustrate exemplary data consumption patterns that may be used by a cloud application to associate a node device with a backhaul node.

FIG. 3 schematically illustrates, in a flow chart type diagram, an embodiment of a method of identifying an association between a backhaul unit and a connected node device in a network as illustrated in FIG. 1, according to the present disclosure.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

Throughout the description of the present disclosure, the terms “backhaul unit”, “backhaul node” are used interchangeably, the terms “node device”, “terminal device” and “node” are used interchangeably.

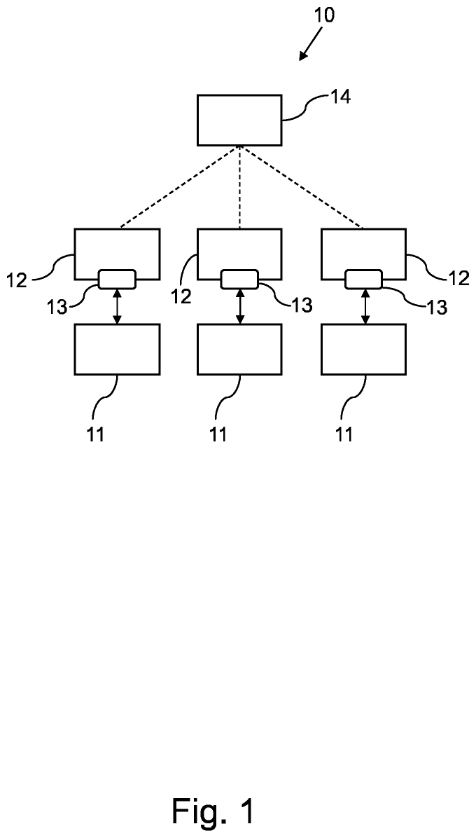

FIG. 1 schematically illustrates a system 10 in which node devices of a network are provided with network connectivity by way of backhaul nodes or backhaul units, in accordance with an embodiment of the present disclosure.

A network comprises a plurality of node devices or terminal devices 11, each of which is connected to a port, such as a Power over Ethernet, PoE, port 13 of a backhaul unit 12 or a PoE port of a POE switch connected to the backhaul unit 12.

The network may be for example a streetlighting system, and the node devices 11 can be PoE based lighting control units or controllers, cameras, sensors, internet of thing, IoT devices, or other node devices supporting PoE connection. These node devices 11, when connected to the PoE ports, will have access to power supply and internet connection. Furthermore it is assumed in the present disclosure that these node devices, once being connected to the internet, will register themselves into a cloud application 14 running for example on a remote device such as a backend server (not shown), and will be ready for use in the cloud application 14.

It is noted that backhaul units with PoE ports are described for exemplary purpose only, a skilled person will understand that power supply via the backhaul unit 12 to the node devices 11 are optional in the context of the present disclosure.

The backhaul unit 12 may be a standard off-shelf product comes from a different entity then an owner of the network, which means little or no hardware and software modification is available for the owner of the network system.

The backhaul unit 12 may interface with a cloud application via available network management protocol, such as through cli or Netconf interface, enabling the cloud application to interact with the backhaul unit. As an example, the cloud application can poll data from the backhaul unit 12, such as each port's transmission TX or receive RX data consumption, packets, errors. Such data are related to a node device 11 connected to the PoE port 13 of the backhaul unit 12.

The could application 14 may be an application running on a backend server arranged for managing the node devices 11. The could application can use an Application Programming Interface, API, or a dedicated communication protocol to control, configure and manage the node devices 11.

As discussed in the background section, for the purpose of asset management, control and monitoring, association between the backhaul units 13 and the connected node devices 11 has to be known to the owner of the network.

Except for the limited information that the could application 14 can obtain from the backhaul units 13, hardly any control over the backhaul units 13 is available for the could application 14. In considering of this situation, it seems that the could application 14 has to rely on the node devices connected to the backhaul units 13 to obtain information on association between the two connected devices.

Unfortunately, except for the power and network connection between the node devices 11 and the backhaul units 12 via the PoE ports 13, there is no internal communication between the backhaul nodes 12 and the node devices, which means the node devices 11 cannot provide information on the association between the backhaul units 12 and the connected node devices to the could application 14 either.

A method of automatically identifying an association between a backhaul unit and a connected node device in a network is disclosed to address the above problem.

The proposed method relies on the limited information that the cloud application 14 can fetch from the backhaul nodes 13 and the capability of the cloud application 14 to control the node devices.

According to the method of the present disclosure, the cloud application can obtain a data consumption pattern related to a node device over a time period. The cloud application can then obtain data consumption patterns from a number of backhaul nodes over the same time period, which allows the cloud application to map or match the data consumption pattern related to the node device to one of the data consumption patterns of the backhaul units. A backhaul unit with the matched data consumption pattern can therefore by identified to be associated with the node device.

The cloud application may negotiate and agree with a node device a data consumption pattern to be consumed by the node device and instructs the node device to consume data according to the negotiated data consumption pattern at a particular time. The cloud application can obtain the data consumption patterns from the backhaul nodes at the same time period.

Alternatively, in the case of the cloud application having more control over the node devices in the network, for example as the result of the node devices and the cloud application being owned by the same entity, the node device may in itself consume data according to a pattern over a certain time period and report the pattern to the cloud application. The cloud application has data consumption patterns of the backhaul units available, as it keeps polling the backhaul units and there have statistic data from the backhaul units.

A data consumption pattern may be defined by one or more of several parameters, including a number of data consumption, a direction of the data (uplink or downlink), timing of the each data consumption and a series of upper values of the data consumptions.

Basically, a data consumption pattern can comprises different kilo bytes or mega bytes in certain continues time frames. Each time frame may have a defined length, preferably at least 1 minute, which will help to avoid too many polling of the backhaul nodes from the cloud application.

Moreover, the amount of data consumption in one time frame has to be detectable by the cloud application. In an example, the amount of data consumption in each time frame is preferably at least 1 kilo bytes.

A data consumption pattern may be differentiated from a further data consumption pattern by for example values-based, binary based or direction based.

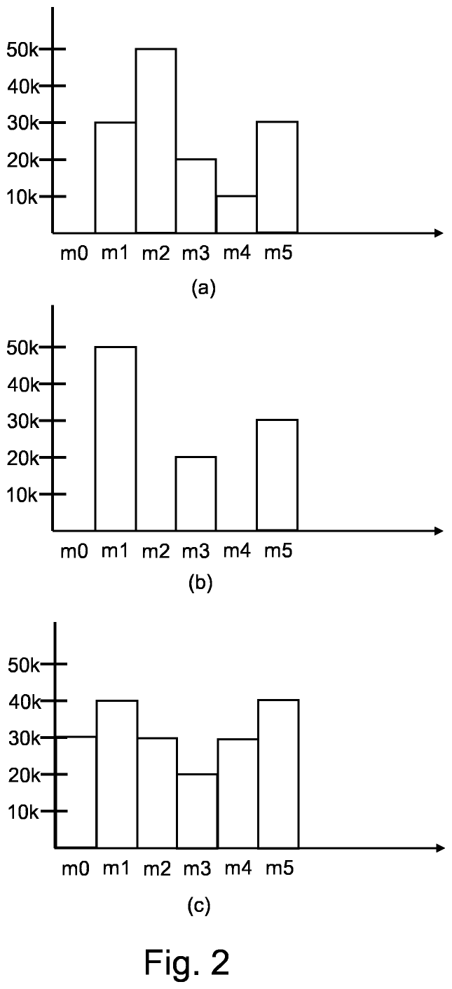

FIGS. 2a to 2c schematically illustrate exemplary data consumption patterns that may be used by the cloud application to associate a node device with a backhaul node.

FIG. 2a illustrates a value based exemplary data consumption pattern. In five time frames m1 to m5 each lasts for example one minute, the amounts of data consumption are respectively defined to be 30 kB, 50 KB, 20 KB, 10 kB and 30 kB. This type of data consumption pattern may be negotiated with a node device which continuously access the network and exchange traffic with the cloud application via the backhaul unit.

FIG. 2b illustrates a value based exemplary data consumption pattern. In the example of FIG. 2b, a node device in five time frames m1 to m5 is supposed to create data consumption in the first, third and fifth time frames m1, m3 and m5, and to consume no data in the second and fourth time frame m2 and m4. The data frame with data consumption may also be defined in terms of the amount of data consumed. The binary based data consumption can be conveniently applied to for example camera devices.

FIG. 2c illustrates a direction based exemplary data consumption pattern. According to this data consumption pattern, a node device will receive data in time frames m1, m3 and m5, and transmit data in time frames m2 and m4. As with the binary based data consumption pattern, the direction based data consumption may also be further defined in terms of the amount of data consumption in each time.

The data consumption can be executed in different ways: download a file from server, or upload a file to server, or start/stop streaming of video to server, or in any other way contemplated by those skilled in the art.

It can be contemplated by those skilled in the art the negotiated data consumption patterns are unique for each of a group of node devices, when association for the group of node devices is performed simultaneously. To this end, a unique data consumption patterns may be generated for the node device based on unique identifications, IDs, of the node devices.

A typical unique ID of a node device is the MAC address of the node devices, which is sufficient for identifying the node device but quite long. For convenience considerations, the cloud application can generates a short length ID for each node device of a group of node devices, based on its MAC address and a number of node devices in the group.

As an example, for a group or batch of 100 node devices, a range of 0-999 may be applicable for generating short IDs. For the purpose of enhancing the detectability, IDs shall have big enough variance.

Table 1 illustrates unique IDs and the corresponding unique data consumption patterns for each node device of a group of five node devices.

TABLE 1
short IDs and data consumption patterns generated for five
node devices based on MAC addresses of the node devices.

| No. | Mac | Unique id | Data consumption pattern |
|---|---|---|---|
| 1 | 01:02:03:05:06:07 | 0x72 | 70K RX(9:00) 20K RX(9:01) |
| 2 | 01:02:03:05:06:08 | 0x38 | 30K TX(9:00) 80K RX(9:01) |
| 3 | 01:02:03:05:06:09 | 0x59 | 50K TX(9:00) 90K TX(9:01) |
| 4 | 01:02:03:05:06:0A | 0xA5 | 100K RX(9:00) 50K TX(9:01) |
| 5 | 01:02:03:05:06:0B | 0xB1 | 110K TX(9:00) 10K RX(9:01) |

The data consumption pattern as described above will be transmitted from the could application to a node device to be associated to its connected backhaul unit, via for example a cloud API or dedicated communication protocol.

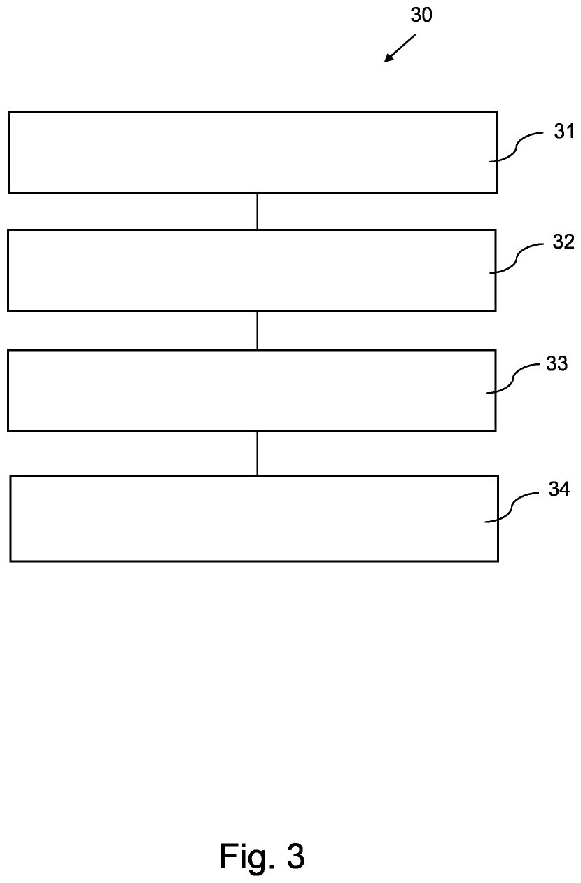

FIG. 3 schematically illustrates, in a flow chart type diagram, an embodiment of a method 30 of identifying an association between a backhaul unit and a connected node device in a network as illustrated in FIG. 1, according to the present disclosure.

At step 31, the cloud application obtains a data consumption pattern related to a node device. The data consumption pattern related to a node device may be performed for example by the node device reporting the data consumption pattern or through negotiation between the cloud application and the node device as described above.

When the data consumption pattern related to the node device is negotiated by the cloud application with the node device, a further step is performed to align with the node device as to the timing of consuming data according to the negotiated data consumption pattern.

As an example, a command comprising the data consumption pattern may be generated and transmitted to the node device, via for example a cloud API or a specific communication protocol. The command further comprises indication as to when to consume data by the node device according to the data consumption pattern, allowing the cloud application to obtain data consumption pattern of the backhaul units at the corresponding time accordingly. The node device will generate traffic according to the received data consumption pattern at the defined period of time.

It is noted that the method may be performed to identify association between a group of node devices and corresponding backhaul units connected to the node devices simultaneously. The cloud application may choose to perform the method at a time when there is little frequent user activities, such as late in the night, so as to keep traffic for purposes other than association to a lower level.

Alternatively, the cloud application may choose to run the method at any time. In this case, the could application may block users from exchanging traffic involving a huge amount of data consumption, such as for updating firmware. This also helps to keep other traffic to a lover volume, which will help to increase the accuracy of the identification procedure.

At step 32, the cloud application obtains data consumption patterns of the backhaul units over the same time period. It can be contemplated by those skilled in the art each data consumption pattern of the backhaul units is identified by or comprise an identification, ID, of a corresponding backhaul unit generating the data consumption pattern, which enables the subsequent association step.

The cloud application always regularly polls the backhaul nodes periodically, for example, once every minute. The cloud application when polling the backhaul units at the defined period of time, will obtain or acquire data consumption patterns of the backhaul units.

As an example, by extracting the PoE port accumulating RX/TX counter of a backhaul unit, the cloud application can determine how much data is consumed on the PoE port of both directions (uplink & downlink) in every minute.

By checking the aligned timing, the cloud application will be able to extract the data consumption pattern of each backhaul unit at the time period when the node device consumes data according to the negotiated or reported data consumption pattern.

At step 33, the cloud application runs an algorithm to match or map the data consumption pattern related to the node device to one of the data consumption patterns of the backhaul units.

The matching of the data consumption pattern related to the node device to a specific one of the data consumption patterns of the backhaul nodes involves calculating a parameter indicating co-relevance between the data consumption pattern related to the node device and each of the data consumption patterns of the backhaul devices and then selecting one of the data consumption patterns having the highest co-relevance of the backhaul nodes. The backhaul node providing the selected data consumption pattern is the one mapped or matched to the node device.

One parameter that may be used is covariance. In practice, covariance check is performed on all combinations between the data consumption pattern related to the node device and each of the data consumption patterns of the backhaul devices, a highest match score corresponding to a backhaul node and the node device indicates that the node device is associated physically to the backhaul node.

As an example, assuming that m node devices are to be matched to m backhaul nodes, a covariance between a node device Y to one of the backhaul nodes Y may be calculated as follows.

1. Obtaining the data consumption pattern of the node device Y, which may comprise for example n data consumption samples (x₁, . . . ,xₙ), and the data consumption pattern of the backhaul nodes Y, which may comprise for example n data consumption samples (x₁, . . . ,xₙ).

2. Calculating average value of the data consumption pattern of the node device X and that of the data consumption pattern of the backhaul node Y according to the following equations:

$$\overline{X} = \frac{{\sum }_{i = 1}^{n} {x}_{i}}{n} \\ \overline{Y} = \frac{{\sum }_{i = 1}^{n} {y}_{i}}{n}$$

3. Calculating the covariance between the data consumption pattern of the node device X and that of the data consumption pattern of the backhaul node Y according to the following equation:

$$Cov ( X , Y ) = \frac{\sum ( {x}_{i} - \overline{X} ) ( {y}_{i} - \overline{Y} )}{n}$$

The above steps are repeated for the node device X and each of the m backhaul nodes to obtain m covariances, a covariance with the highest value is selected as indicating a matching between the node device X and one of the backhaul nodes. The node devices x and the matched backhaul nodes are then associated to each other by associating their IDs.

It is noted that the above association procedure may be performed by starting with a specific backhaul node and calculating m covariances between the backhaul node with each of the m node devices.

It is further noted that the data consumption pattern of a backhaul node refers to the data consumption pattern of a communication port of a backhaul node, when the backhaul node supports multiple communication ports, for example by way of connecting to a switch having multiple communication ports.

It can be contemplated by those skilled in the art that any other indicator that may indicate the co-relevance between the data consumption pattern related to the node device and that data consumption patterns of the backhaul nodes may be used for the matching step as described above.

As a further example, another correlation coefficient that may be used is the so-called Pearson coefficient, which may be calculated according to the following equation:

$${r}_{xy} = \frac{\sum ( {x}_{i} - \overline{x} ) ( {y}_{i} - \overline{y} )}{\sqrt{\sum {( {x}_{i} - \overline{x} )}^{2} \sum {( {y}_{i} - \overline{y} )}^{2}}}$$

where r_{xy} is a Pearson correlation coefficient between the data consumption pattern of the node device X and that of the data consumption pattern of the backhaul node Y, both comprising a plurality of data samples corresponding to a number of data consumptions within a time period, and i is an index of the data samples.

Calculating Pearson coefficient is a well-established way of finding correlations between different data, which can be readily used in the present disclosure to find the proper matching between the node devices and the backhaul nodes.

At step 34, the cloud application associates the node device to a backhaul unit having the matched data consumption pattern.

The cloud application can automatically link the IDs into one manageable entity, and share GPS location, if also available, between each other.

A detailed exemplary embodiment implementing the above method of the present disclosure will be described in the following. In this example, backhaul nodes are installed at a streetlight system, for example on lighting poles. Lighting controller are connects to communication ports, such as PoE port supported by the backhaul nodes to get internet, and optionally power supply.

Each lighting controller may optionally be further equipped with a GPS module, while the backhaul nodes are not equipped with any GPS devices.

A light controller may be for example a PoE lighting controller, which is a plug and play type cellular node. Once a light controller gets powered up and internet, it can register itself to a remote device, such as a cloud application running on a backend server, reporting its location and starting to operate under control of the cloud application.

The cloud application can get a list of backhaul nodes and PoE lighting controllers, and their unique IDs. The cloud application may generate a unique data consumption pattern, based on PoE lighting controllers' unique IDs. The data consumption patterns between different PoE lighting controllers may be differentiated in terms of one or more of the following dimensions: number of data consumed by a PoE device, direction, that is, RX or TX, of each data consumption, presence/absence of data consumed, start timing point (when) and detection interval (e.g., 1 minute as one point).

The cloud application may transfer the data consumption patterns for different node devices into commands, and send those commands to corresponding PoE lighting controllers.

Referring to the above Table 1, take the first device as example, the command will instruct the PoE lighting controller to download a file, with a size of 70 K at 9:00, and to download 20 K file again at 9:01.

The PoE lighting controller follows the command, and execute the command at a specific timing point.

The cloud application can poll the five backhaul nodes connected to the five lighting controllers and get two data points at 9:00-9:01 and 9:01-9:02 for each of the backhaul nodes.

The cloud application will then calculate the covariance between the two data consumptions of the first node device with each of the data consumption of each of the five backhaul nodes. The cloud application may further refer to the absolute value of each data consumption for the matching step. It can thereby decide that which backhaul node is connected to the first lighting controller with the ID of 0×72. The thus matched backhaul node and PoE lighting controller are then associated to each other by way of their IDs.

The method as described is applicable to various application scenarios involving node devices connected to backhaul units which provide network connectivity to the node devices, such as a streetlighting system.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1. A method of identifying association of a backhaul unit to a node device which is already connected to the backhaul unit in a network, the network comprising a plurality of backhaul units each arranged for connecting to a node device and for providing network connection to the node device, the method comprising the steps of:
obtaining a data consumption pattern of a node device over a time period;
obtaining data consumption patterns of the plurality of backhaul units over the same time period;
matching the data consumption pattern of the node device to one of the data consumption patterns of the plurality of backhaul units; and
identifying association of the node device to a backhaul unit having the matched data consumption pattern.

2. The method according to claim 1, wherein the data consumption pattern of the node device is negotiated by a remote application with the node device, the method comprising, subsequent to the step of obtaining a data consumption pattern of a node device over a time period, a further step of:
aligning with the node device about the time period of the data consumption pattern.

3. The method according to claim 1, wherein the data consumption pattern of the node device is obtained from the node device, the step of obtaining data consumption patterns of the plurality of backhaul units over the same time period comprises retrieving stored data consumption patterns of the plurality of backhaul units over the same time period.

4. The method according to claim 1, wherein the data consumption pattern of a node device comprises a number of data consumptions in consecutive time frames of the same number.

5. The method according to claim 4, wherein the data consumption pattern of a node device further comprises at least one of a volume of each data consumption, a direction of each data consumption and presence/absence of each data consumption.

6. The method according to claim 4, wherein each non-zero data consumption is at least one kilobytes in each time frame.

7. The method according to claim 1, wherein a backhaul unit is configured to support a plurality of communication ports,
the step of obtaining data consumption patterns of the plurality of backhaul units over the same time period comprises obtaining data consumption of each communication ports of the plurality of backhaul unit over the same time period;
the step of matching comprises matching the data consumption pattern of the node device to one of the data consumption patterns of communication ports of the plurality of backhaul units; and
the step of identifying association comprises identifying association of the node device to a communication port of a backhaul unit having the matched data consumption pattern.

8. The method according to claim 1, wherein the step of matching comprises the steps of:
calculating an indicator of relevance of the data consumption pattern of the node device with each data consumption pattern of the backhaul units; and
matching the data consumption pattern of the of the node device to a data consumption pattern of the backhaul unit with an indicator indicating a highest relevance.

9. The method according to claim 8, wherein the indicator of relevance is based on a covariance or a Pearson coefficient between the data consumption pattern related to the node device and each data consumption pattern of the backhaul units.

10. The method according to claim 9, wherein the indicator of relevance is further based on absolute values of the data consumption pattern of the node device and of data consumption patterns of the backhaul units.

11. The method according to claim 1, further comprising the step of blocking the node device from creating data consumption above a defined threshold during the time period.

12. The method according to claim 1, wherein each node device is identified by a unique node identification, each backhaul unit is identified by a unique backhaul identification, the step of identifying association comprises identifying association of a unique node identification of the node device with a unique backhaul identification of a backhaul unit having the matched data consumption pattern.

13. The method according to claim 1, wherein each backhaul unit is installed on a light pole and supports one or more Power over Ethernet, PoE, port, and a node device comprises at least one of a lighting controller, a camera and a sensor.

14. A system for identifying association of a backhaul unit to a node device connected to the backhaul unit in a network, according to the method according to claim 1, the network comprising a plurality of backhaul units each arranged for connecting to a node device and for providing network connection to the node device.

15. A computer program product, comprising a computer readable storage medium storing instructions which, when executed on at least one processor, cause said at least one processor to carry out the method according to claim 1.
